(19) United States
(12) Patent Application Publication
(10) Pub. No.: US 2002/0162416 A1
(43) Pub. Date: Nov. 7, 2002

(54) Steering wheel mounted stress relief device

(76) Inventor: Danny Gemma, South San Francisco, CA (US)

Correspondence Address: Richard W. Goldstein, 2071 Clove Road, Staten Island, NY, 10304, US

(21) Appl. No.: 09/849,829

(22) Filed: May 7, 2001

(51) Int. Cl. B62D 1/06

(52) U.S. Cl. 74/558

(57) ABSTRACT

A stress relief steering wheel cover attached to the rim of a steering wheel. The covers are composed of sac assemblies mounted onto the steering wheel. The sac assemblies are comprised of outer and inner layers. The inner layer housing particulate material. The outer layer is made out of a soft cushion material. The covers are generally “C” shaped, having a narrow opening along one side to allow the cover to be fitted around the steering wheel. A strip of hook and loop fasteners is attached at each end of the opening and serves to fasten the cover around the steering wheel. Alternatively, the stress relief covers may be incorporated directly into the steering wheel. While driving and experiencing stress, the driver would place his or her hands around the covers and squeeze tightly in order to reduce his or her stress level.

### BACKGROUND OF THE INVENTION

The invention relates to a stress relief cover applied over a standard automobile steering wheel. In particular, the invention is a device that covers the outer surface of a steering wheel, thereby allowing the driver to squeeze the coating during stressful driving times.

Stress is the combination of psychological, physiological, and behavioral reactions that people have in response to events that threaten or challenge them. Stress normally has harmful effects when not managed effectively. Moreover, stress can increase the risk of developing physiological, as well as physical, health problems, such as cardiovascular disease and anxiety disorders. This bad kind of stress is referred to as distress, the kind of stress that people usually are referring to when they use the word stress.

Stressors are the sources of stress, and may include events ranging in severity from daily hassles, major life events, and catastrophes. Generally, it is the daily hassles that cause people the most stress since these hassles are most often encountered on a day-to-day basis. Reactions to these stressors can range from tension, irritability, and nervousness to anger.

Driving has become a major stressor for many people who are forced to drive during the course of their day. Traffic, as well as reactions to other drivers, can cause extreme stress, commonly referred to as “road rage”. While driving, people find themselves getting anxious and enraged because of frustrations caused by various road conditions. This type of stress has lead to numerous accidents.

Thus, there exists a need for a device which may act to reduce the levels of stress encountered while driving. Such a device should be readily available for the driver and easily manipulated.

While the available units may be suitable for the particular purpose employed, or for general use, they would not be as suitable for the purposes of the present invention as disclosed hereafter. SUMMARY OF THE INVENTION

In view of the foregoing disadvantages inherent in the prior art, the present invention provides an improved stress relief steering wheel cover. As such, the general purpose of the present invention, which will be described subsequently in greater detail, is to provide a new and improved stress relief steering wheel cover which has all the advantages of the prior art and none of the disadvantages.

To attain this, the present invention essentially comprises a stress relief steering wheel cover attached to the rim of a steering wheel. The covers are composed of sac assemblies mounted onto the steering wheel. The sac assemblies are comprised of outer and inner layers with particulate material situated in between. The outer layer is made out of a soft cushion material. The covers are generally “C” shaped, having a narrow opening along one side to allow the cover to be fitted around the steering wheel. A strip of hook and loop fasteners is attached at each end of the opening and serves to fasten the cover around the steering wheel. Alternatively, the stress relief covers may be incorporated directly into the steering wheel. While driving and experiencing stress, the driver would place his or her hands around the covers and squeeze tightly in order to reduce his or her stress level.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved stress relief steering wheel cover which has all the advantages of the prior art and none of the disadvantages.

It is another object of the present invention to provide a new and improved stress relief steering wheel cover which may be easily and efficiently manufactured and marketed.

It is a further object of the present invention to provide a new and improved stress relief steering wheel cover which is of durable and reliable construction.

An even further object of the present invention is to provide a new and improved stress relief steering wheel cover which is susceptible to a low cost of manufacture with regard to both materials and labor, and which accordingly is then susceptible of low prices of sale to the consuming public, thereby making such stress relief steering wheel cover economically available to the buying public.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a perspective view of an automobile steering wheel with stress relief steering wheel covers positioned on the rim of the steering wheel.

FIG. 2 is a cross sectional view of a stress relief steering wheel cover.

FIG. 3 is a cross sectional view of the steering wheel, with a stress relief steering wheel cover positioned thereon.

FIG. 4 is a front elevational view of the steering wheel, with the stress relief device cut away.

### DETAILED DESCRIPTION OF THE PREFERRED EMBODIMENTS

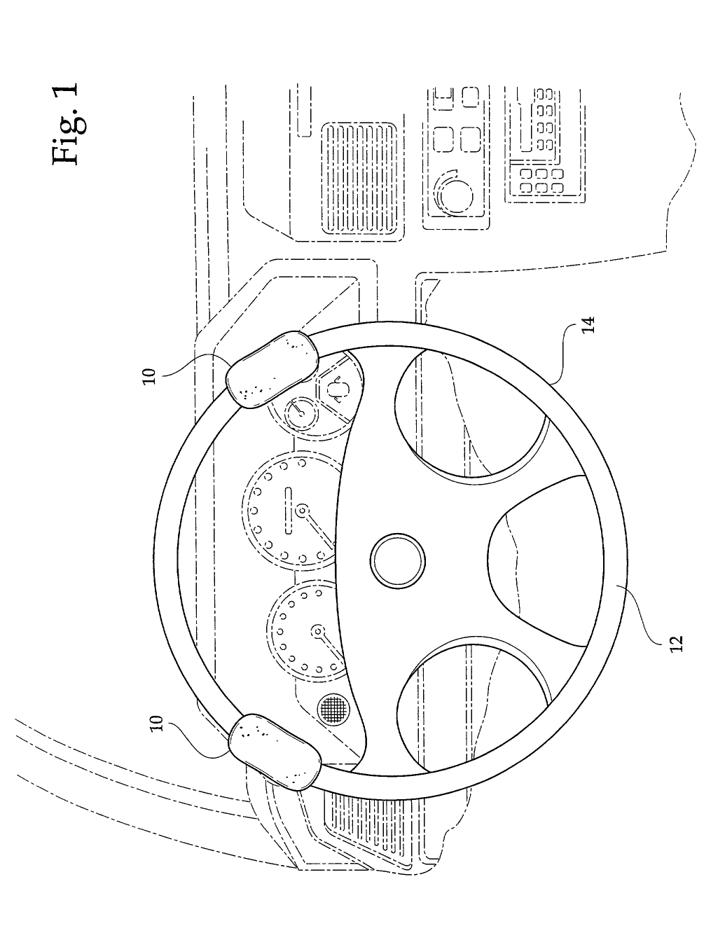

FIG. 1 illustrates a pair of stress relief steering wheel cover 10 that is applied to an automobile steering wheel 12. The steering wheel 12 has a rim 14 that extends around the entire perimeter of the wheel 12. When driving, a driver typically places his or her hands around this rim 14 in order to control and steer the automobile. Safe driving dictates that two hands be kept on the wheel 12, preferably at the “10:00”, and “2:00” positions. Thus, the stress relief covers 10 are preferably placed at these positions.

The covers 10 are composed of sac assemblies mounted onto the steering wheel 12. The sac assemblies are comprised of outer and inner layers 16, 18, respectively. The outer layer 16 extends around the entire cover 10 and secures the contents of the inner layer 18 therein. The outer layer 16 defines a compartment housing particulate material 20, namely seeds, pebbles, silicon or the equivalent which are often use in other stress relief devices. The outer layer 16 is made out of a soft flexible material, such as rubber. Such a material would provide a driver with a soft gripping area, conducive to the relief of stress while driving.

As illustrated in FIG. 3, the covers 10 are “C” shaped, having a narrow longitudinal opening along one side. This opening allows the cover 10 to be fitted around the steering wheel 12. A strip of hook and loop fasteners 22 is attached at each side of the opening. The covers 10 are sized to extend along approximately 1/16″ to 1/8″ of the overall perimeter of the rim 14. Once positioned around the rim 14 of the steering wheel, the strips 22 are mated, thereby securing the cover 10 in place on the wheel 12. This construction allows the covers 10 to be moved according to one's driving habits or removed completely.

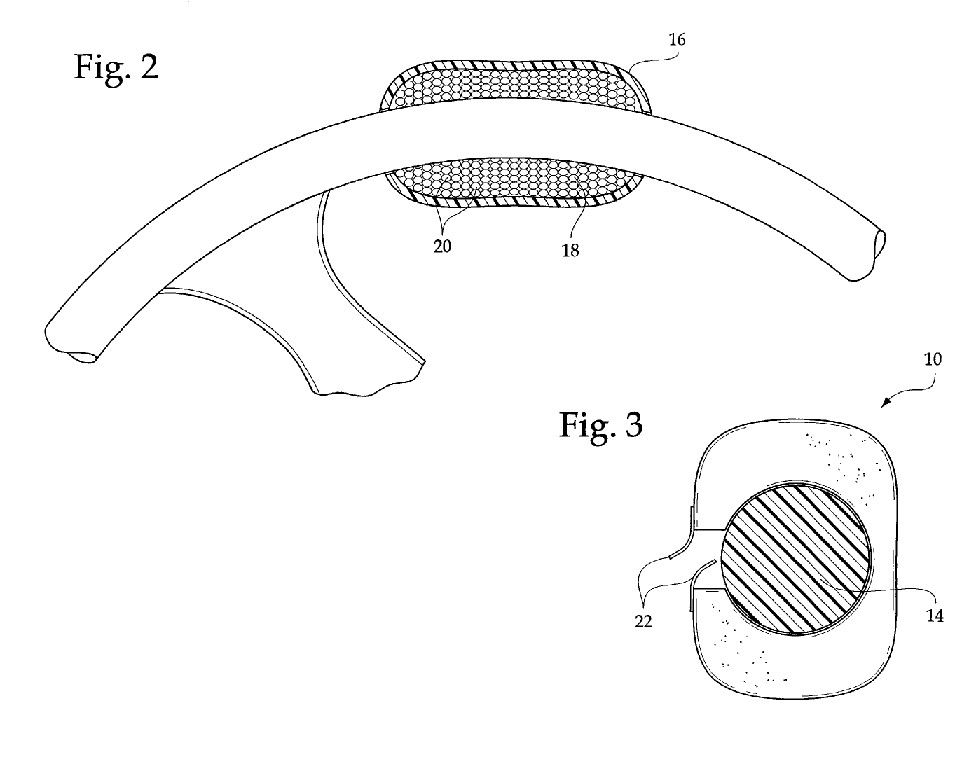

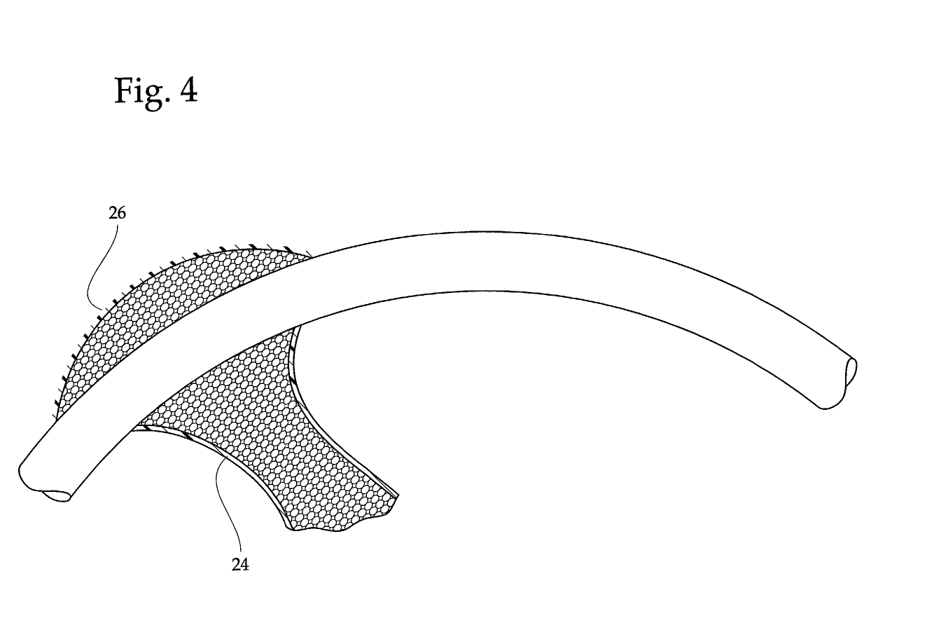

In an alternate embodiment, the stress relief covers 10 may be incorporated directly into the steering wheel 12. This may be accomplished by incorporating the particulate material 20 directly between the outer layer 16 and the rim 14 of the wheel 12 or spokes 24 contained within the rim 14 of the steering wheel 12, as seen in FIG. 2 or FIG. 4. In this embodiment, bulges 26 situated strategically around the rim 14 of the wheel or the entire spoke 24 comprise the layers described above. When stressed, a driver would place his or her hands around one or more of the spokes 24 or bulges 26 and squeeze in order to relieve stress.

Regardless of the type of stress relief steering wheel cover that is employed, the use remains the same. While driving and experiencing stress, the driver would place his or her hands around the covers 10 and squeeze tightly. It has been found that this type of release of energy can reduce the level of stress, along with the emotional responses associated therewith. Because of the positioning of the covers 10, they are within convenient reach of the driver's hands.

In conclusion, herein is presented a stress relief steering wheel cover. The invention is illustrated by example in the drawing figures, and throughout the written description. It should be understood that numerous variations are possible, while adhering to the inventive concept. Such variations are contemplated as being a part of the present invention.

What is claimed is:

1. A stress relief steering wheel cover, the cover being situated on an automobile steering wheel, said steering wheel having an outer rim, comprising:
a sac assembly, having an outer layer and an inner layer;
the inner layer positioned on the rim of the steering wheel; and
particulate material contained between the outer layer and inner layer.

2. The stress relief steering wheel cover as recited in claim 1, wherein the sac assembly is “C” shaped, having a narrow longitudinal opening along one side of said assembly.

3. The stress relief steering wheel cover as recited in claim 2, further comprising a strip of hook and loop fasteners positioned at opposite sides of the opening of the sac assembly, said strips being matable in order to secure the cover around the steering wheel rim.

4. A stress relief steering wheel cover, the cover being situated on an automobile steering wheel, said steering wheel having an outer rim and interior spokes, comprising:
bulges situated along the rim and the spokes of the steering wheel;
particulate material housing within the bulges.
